(19) United States
(12) Patent Application Publication
(10) Pub. No.: US 2026/0249160 A1
(43) Pub. Date: Aug. 27, 2026

(54) METHOD AND SYSTEM FOR ESTIMATING INFORMATION ABOUT GOLF SWING

(71) Applicant: CREATZ INC., Suwon-si Gyeonggi-do (KR)

(72) Inventors: Jey Ho SUK, Seoul (KR); Jong Tack KIM, Seoul (KR); Do Hwan OH, Jeju-si Jeju-do (KR)

(73) Assignee: CREATZ INC., Suwon-si Gyeonggi-do (KR)

(21) Appl. No.: 19/537,811

(22) Filed: Feb. 12, 2026

(30) Foreign Application Priority Data
Feb. 14, 2025 (KR) 10-2025-0019547

(51) Int. Cl. A63B 71/06; A63B 24/00; G06V 10/82; G06V 40/10; G06V 40/20

(52) U.S. Cl. CPC A63B 71/0622; A63B 24/0006; A63B 24/0087; G06V 10/82; G06V 40/10; G06V 40/23; A63B 2024/0096; A63B 2071/0636; A63B 2071/0647; A63B 2220/807

(57) ABSTRACT

Provided is a method for providing information on a golf swing. The method includes acquiring at least one image of a user's golf swing; and generating three-dimensional (3D) information on the user's golf swing on the basis of the acquired at least one image of the user's golf swing. The generation of the 3D information is performed through a deep learning model.

### CROSS-REFERENCE TO RELATED APPLICATION

This application claims priority to Korean Patent Application No. 10-2025-0019547 filed on February 14, 2025, the entire contents of which are herein incorporated by reference.

### FIELD OF THE INVENTION

The present invention relates to a method and system for estimating information on a golf swing.

### BACKGROUND

In recent years, numerous techniques have been introduced to provide golfers with useful information, such as analyzing and using swing videos of the golfers to identify points for swing form correction.

Conventionally, a golfer's swing has been analyzed using a face-on (FO) camera positioned in front of the golfer and a down-the-line (DTL) camera positioned behind the golfer. However, the techniques introduced so far as well as the conventional techniques are disadvantageous in that the FO and DTL cameras can interfere with the golfer's swing motion or field of vision, and the accuracy of the swing analysis is compromised due to limited three-dimensional (3D) information.

In this connection, the inventor(s) present a technique capable of deriving accurate swing analysis results using rich 3D information, without interfering with a golfer's swing or a ball's trajectory.

### SUMMARY OF THE INVENTION

One object of the present invention is to solve all the above-described problems in the prior art.

Another object of the invention is to acquire at least one image of a user's golf swing, and generate three-dimensional (3D) information on the user's golf swing on the basis of the acquired at least one image of the user's golf swing, wherein the generation of the 3D information is performed through a deep learning model.

Another object of the invention is to provide a high-quality golf-related content including swing feedback by generating and analyzing 3D information from two-dimensional (2D) images photographed from an overhead view that does not interfere with a golfer's swing motion or field of vision.

The representative configurations of the invention to achieve the above objects are described below.

According to one aspect of the invention, there is provided a method comprising the steps of: acquiring at least one image of a user's golf swing; and generating three-dimensional (3D) information on the user's golf swing on the basis of the acquired at least one image of the user's golf swing, wherein the generation of the 3D information is performed through a deep learning model.

According to another aspect of the invention, there is provided a system comprising: an image acquisition unit configured to acquire at least one image of a user's golf swing; and a three-dimensional (3D) information generation unit configured to generate 3D information on the user's golf swing on the basis of the acquired at least one image of the user's golf swing, wherein the generation of the 3D information is performed through a deep learning model.

In addition, there are further provided other methods and systems to implement the invention, as well as non-transitory computer-readable recording media having stored thereon computer programs for executing the methods.

According to the invention, it is possible to acquire at least one image of a user's golf swing, and generate 3D information on the user's golf swing on the basis of the acquired at least one image of the user's golf swing, wherein the generation of the 3D information is performed through a deep learning model.

According to the invention, it is possible to provide a high-quality golf-related content including swing feedback by generating and analyzing 3D information from two-dimensional (2D) images photographed from an overhead view that does not interfere with a golfer's swing motion or field of vision.

### BRIEF DESCRIPTION OF THE DRAWINGS

FIG. 1 schematically shows the configuration of an entire system for providing information on a golf swing according to one embodiment of the invention.

FIG. 2 specifically shows the internal configuration of a swing information provision system 200 according to one embodiment of the invention.

FIG. 3 illustratively shows a training or inference process in which 3D information on a golf swing is generated through a first and a second overhead view 2D image acquired by an image acquisition unit 210 according to one embodiment of the invention.

FIG. 4 illustratively shows an inference process in which 3D information on a golf swing is generated through a single 2D image acquired by the image acquisition unit 210 according to one embodiment of the invention.

FIG. 5 illustratively shows a 3D avatar 610 visualized by a3D information generation unit 220 according to one embodiment of the invention and swing information 620 including feedback.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the entire system

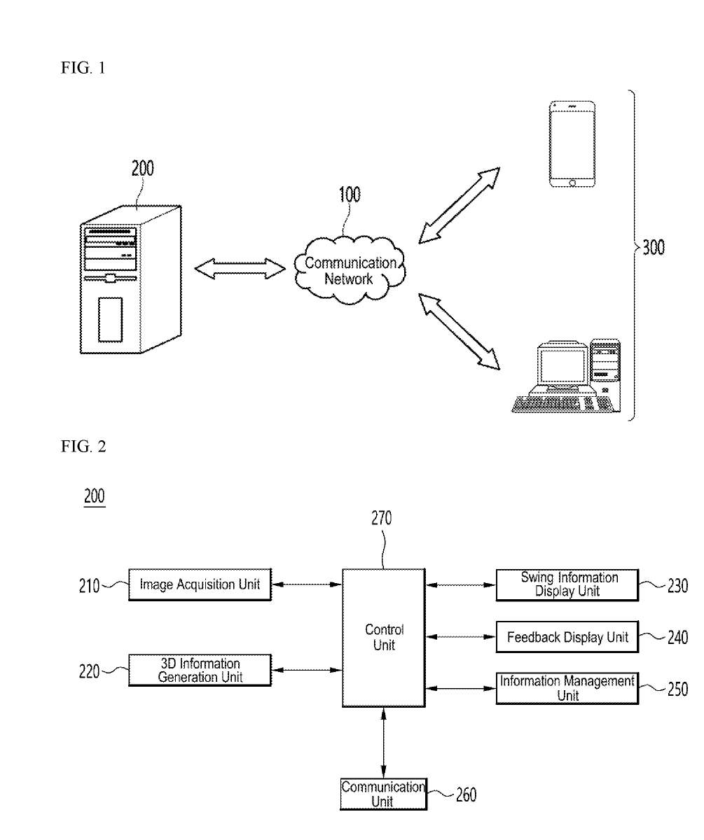

FIG. 1 schematically shows the configuration of the entire system for providing information on a golf swing according to one embodiment of the invention.

As shown in FIG. 1, the entire system according to one embodiment of the invention may comprise a communication network 100, a swing information provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the swing information provision system 200 according to one embodiment of the invention may function to acquire at least one image of a user's golf swing, and generate three-dimensional (3D) information on the user's golf swing on the basis of the acquired at least one image of the user's golf swing, wherein the generation of the 3D information is performed through a deep learning model.

The configuration and functions of the swing information provision system 200 according to the invention will be discussed in more detail below.

Next, the device 300 according to one embodiment of the invention is digital equipment capable of connecting to and then communicating with the swing information provision system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with services such as golf swing information from the swing information provision system 200. The application may be downloaded from the swing information provision system 200 or an external application distribution server (not shown). Meanwhile, the characteristics of the application may be generally similar to those of an image acquisition unit 210, a 3D information generation unit 220, a swing information display unit 230, a feedback display unit 240, an information management unit 250, a communication unit 260, and a control unit 270 of the swing information provision system 200 to be described below. Here, at least a part of the application may be replaced with a hardware device or a firmware device that may perform a substantially equal or equivalent function, as necessary.

### Configuration of the swing information provision system

Hereinafter, the internal configuration of the swing information provision system 200 crucial for implementing the invention and the functions of the respective components thereof will be discussed.

FIG. 2 specifically shows the internal configuration of the swing information provision system 200 according to one embodiment of the invention.

As shown in FIG. 2, the swing information provision system 200 according to one embodiment of the invention may comprise an image acquisition unit 210, a 3D information generation unit 220, a swing information display unit 230, a feedback display unit 240, an information management unit 250, a communication unit 260, and a control unit 270. According to one embodiment of the invention, at least some of the image acquisition unit 210, the 3D information generation unit 220, the swing information display unit 230, the feedback display unit 240, the information management unit 250, the communication unit 260, and the control unit 270 may be program modules to communicate with an external system (not shown). The program modules may be included in the swing information provision system 200 in the form of operating systems, application program modules, and other program modules, while they may be physically stored in a variety of commonly known storage devices. Further, the program modules may also be stored in a remote storage device that may communicate with the swing information provision system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the swing information provision system 200 has been described as above, and it will be apparent to those skilled in the art that at least a part of the components or functions of the swing information provision system 200 may be implemented in the device 300 or a server (not shown) or included in an external system (not shown), as necessary.

First, the image acquisition unit 210 according to one embodiment of the invention may function to acquire at least one image of a user's golf swing.

The user according to one embodiment of the invention may refer to a subject who provides a 2D image used by the swing information provision system 200 to generate 3D information. Specifically, the user may refer to a golf player using the swing information provision system 200 according to one embodiment of the invention or the device 300 including the same, who is visualized as a 3D virtual body model or 3D avatar to be described later.

The golf swing according to one embodiment of the invention should be understood in the broadest sense as encompassing all motions for moving a golf club or striking a golf ball by moving the golf club, and may include, but is not limited to, a full swing, a half swing, a chip shot, a lob shot, a putt, and the like.

The at least one image acquired by the image acquisition unit 210 according to one embodiment of the invention may refer to a single 2D image in which the user's golf swing is photographed. Specifically, the single 2D image may refer to one 2D image acquired by photographing the user's golf swing from an overhead view. The swing information provision system 200 according to the invention may generate 3D information on the user's golf swing through just a single image (or a single overhead view image) in which the user's golf swing is photographed. More specifically, the swing information provision system 200 according to the invention may generate 3D information on the user's golf swing with high accuracy through just one 2D image (or one overhead view image) in which the user's golf swing is photographed. In the case of conventional techniques, at least two 2D images in which the same object (i.e., the user or the user's golf swing) is photographed from different angles are required to generate 3D information on the basis of 2D images. However, the swing information provision system 200 according to one embodiment of the invention utilizes a deep learning model with characteristics to be described later, so that 3D information may be generated (or inferred) with high accuracy on the basis of only one 2D image.

Meanwhile, the swing information provision system 200 according to the invention may also generate 3D information on the user's golf swing through two or more images in which the user's golf swing is photographed from different angles. In such cases, the accuracy of estimating the 3D information may be improved compared to when only a single image is used. However, improving the accuracy through the two or more images is merely an optional configuration, and should not be interpreted to mean that it is impossible to generate 3D information through a single image or that the accuracy would be low when generating 3D information through a single image.

Further, the image acquisition unit 210 according to one embodiment of the invention may acquire at least one overhead view 2D image of the user's golf swing through at least one photographing device. Specifically, the swing information provision system 200 or the deep learning model according to one embodiment of the invention may generate (or infer) 3D information on the user's golf swing on the basis of at least one overhead view 2D image in which the user's golf swing is photographed.

The overhead view according to one embodiment of the invention may refer to a viewpoint looking down at the user from above, and the overhead view 2D image according to one embodiment of the invention may refer to a 2D image photographed from a viewpoint looking down at the user (or the user's golf swing) from above.

Specifically, acquiring an overhead view image by the photographing device according to one embodiment of the invention may mean that the photographing device is positioned at a location relatively higher than the user and photographs the user or the user's golf swing in a downward direction. The photographing device being positioned at a location relatively higher than the user may mean, for example, that the photographing device is attached to and installed on (i) a drone, (ii) a ceiling of a building (e.g., a ceiling of a space, room, or building where a screen golf system including the swing information provision system 200 according to one embodiment of the invention is positioned), or (iii) a fixed support (e.g., a tripod, boom arm, magic arm, clamp, jib arm, crane, pole mount, or ladder), such that the photographing device is positioned at a location relatively higher than the user. However, the means by which the photographing device is positioned at a location relatively higher than the user is not limited to the foregoing but may be changed without limitation as long as it is consistent with the objects of the invention.

The photographing device according to one embodiment of the invention may refer to a device capable of acquiring at least one image of the user's golf swing. Specifically, the photographing device according to one embodiment of the invention may be a swing cam system including one or more cameras, and the at least one image of the user's golf swing may be an overhead view image (or an overhead view 2D image) when the photographing device is a swing cam system including one or more cameras.

The swing cam according to one embodiment of the invention may refer to a camera device (or a system including the same) used to photograph and analyze a golf swing, and may assist in analyzing swing postures, club movements, and the like by accurately recording swing motions of the user (or golfer).

Specifically, the photographing device according to one embodiment of the invention may refer to an (all-in-one) ceiling-mounted golf simulator that includes at least one camera and may recognize the golf ball, the golf club, and the user's swing motions through the at least one camera while simultaneously simulating golf play. Therefore, the photographing device according to one embodiment of the invention is positioned at a location relatively higher than the user as described above, so that it does not interfere with the user's movement and has the advantages of easy installation and a neat appearance since separate space and wiring for installation are not required.

The photographing device according to one embodiment of the invention may include two or more cameras. Specifically, when two or more cameras are included in the photographing device according to one embodiment of the invention, it is advantageous in that the process of calibrating the two or more cameras becomes much easier compared to when the two or more cameras are installed separately. Further, by having the two or more cameras built into the photographing device, situations where the user touches a camera and necessitates recalibration may be minimized compared to when the cameras are external.

Further, when the photographing device for photographing the user's golf swing includes two or more cameras, it may be required to maintain a predetermined distance (e.g., 1 meter or more) from the subject (e.g., the user's golf swing) in order to photograph the subject using the two or more cameras.

Meanwhile, when a single photographing device includes two or more cameras, the image acquisition unit 210 may acquire two or more overhead view 2D images photographed from different angles through the two or more cameras.

According to one embodiment of the invention, acquiring two or more 2D images photographed from different angles through "one" photographing device may mean photographing 2D images through two or more different cameras included in the one photographing device. For example, the two or more 2D images photographed from different angles may be acquired through two or more cameras that are included in a single ceiling-mounted swing cam system and configured to photograph views from different angles.

The photographing device according to one embodiment of the invention may include a luminaire. The luminaire may illuminate the user (or the user's golf swing) to enable the photographing device or the camera included in the photographing device to photograph clearer 2D images.

Meanwhile, instead of using a separate luminaire, the photographing device may include both a camera and a luminaire together, and the camera and luminaire may be precisely synchronized to minimize lighting strobes and glare resulting therefrom.

Further, the luminaire included in the photographing device may be a visible light luminaire or an infrared luminaire. Meanwhile, the type of light generated by the luminaire included in the photographing device and the type of light captured or detected by the camera included in the photographing device may be the same. For example, the camera included in the photographing device may be a visible light camera when the luminaire included in the photographing device is a visible light luminaire, and the camera included in the photographing device may be an infrared camera when the luminaire included in the photographing device is an infrared luminaire.

Meanwhile, the photographing device according to one embodiment of the invention may accurately analyze detailed motions by photographing the user's golf swing at high speed. However, the exposure time becomes shorter for high-speed photographing, and a luminaire for providing appropriate brightness may be required in order to photograph 2D images with a level of resolution (or clarity) necessary for analysis despite the short exposure time.

Further, when an infrared camera is used as the photographing device, sufficient resolution may be acquired even if the lighting intensity is weaker compared to a visible light luminaire, which has the advantage of preventing glare for the user. Meanwhile, when a visible light camera is used as the photographing device, the lighting intensity should be relatively strong to acquire sufficient resolution, which may cause glare. However, the glare may be minimized by embedding a visible light luminaire itself into the photographing device and precisely synchronizing the luminaire and the photographing device to minimize strobes and glare. Consequently, the type of luminaire that may be used with the photographing device according to one embodiment of the invention and whether the luminaire is internal or external may be selected as needed, considering the characteristics of each luminaire described above.

In addition, the image acquisition unit 210 according to one embodiment of the invention may further acquire information on the golf ball through at least one photographing device. Specifically, along with photographing the user's golf swing as described above, the image acquisition unit 210 according to one embodiment of the invention may also acquire information on the golf ball to be struck by the user through the swing.

The information on the golf ball may include a physical quantity (or a change in the physical quantity) of the golf ball struck by the user's swing. Specifically, the information on the golf ball may include at least one of a direction and speed (or an amount of change in at least one of the direction and speed) of the golf ball struck by the swing.

That is, unlike conventional devices for implementing virtual golf simulations that essentially require two swing cameras at front and lateral sides to analyze a user's swing, the photographing device according to one embodiment of the invention may analyze the user's swing with high accuracy using the deep learning model with only one photographing device (specifically, one ceiling-mounted photographing device). In addition, by further including a camera capable of photographing the golf ball as described above, the photographing device according to one embodiment of the invention may provide an all-in-one and ceiling-mounted photographing device that may acquire information on both the user's swing and the ball and implement a virtual golf simulation using only one photographing device, without a separate ball camera. Through the all-in-one and ceiling-mounted photographing device, visibility of the analysis equipment in the user's field of vision is minimized, thereby maximizing the user's immersion and minimizing interference with the movements of the user and the play process of the virtual golf simulation.

Meanwhile, further acquiring information on the golf ball by the image acquisition unit 210 using at least one photographing device may mean photographing the golf ball through the photographing device used to photograph the user's golf swing, thereby acquiring information that may assist a separate dedicated camera for photographing the golf ball (i.e., a ball camera). That is, while at least two ball cameras (i.e., cameras for photographing the golf ball, distinct from the camera for photographing the user's swing) are generally required to simulate a golf ball in a golf simulator, the image acquisition unit 210 or the photographing device according to one embodiment of the invention may assist the ball camera by photographing the golf ball at the same time as the user's swing to acquire information on the golf ball, which allows for accurate simulation of the struck golf ball using only one ball camera.

Consequently, the photographing device for photographing the user's golf swing according to one embodiment of the invention may additionally collect information on the golf ball, and thus may be used as an auxiliary means for a device for photographing the golf ball (e.g., a ball camera).

Meanwhile, the photographing device according to one embodiment of the invention may be configured to include at least one swing-dedicated camera for photographing the user's swing, and at least one ball-dedicated camera for photographing only the golf ball, which is distinct from the former. That is, the photographing device according to one embodiment of the invention may acquire information on the golf ball using the swing camera as described above, but alternatively, may separately include a swing-dedicated camera for photographing only the swing and a ball-dedicated camera distinct from the former.

Specifically, the photographing device may include a camera capable of acquiring two different overhead view 2D images of the user's golf swing and a camera capable of acquiring two different images of the golf ball.

More specifically, the two different overhead view 2D images of the user's golf swing may be acquired through two different swing-dedicated cameras included in the photographing device, and the two different images of the golf ball may be acquired through two different ball-dedicated cameras included in the photographing device. Here, different images may refer to images in which the same object (e.g., one user's swing or one golf ball) is photographed from different angles.

Specifically, the photographing device according to one embodiment of the invention may be provided as a ceiling-mounted device (e.g., a ceiling-mounted sensor) including two swing-dedicated cameras and two ball-dedicated cameras. Even when the photographing device is provided in this manner, all of the plurality of cameras described above are provided inside a single photographing device, so that the photographing device has the advantage of being able to photograph and analyze both the user's swing and the golf ball with only one ceiling-mounted device, unlike conventional photographing devices where multiple cameras are placed separately at the front and lateral sides of the user.

Meanwhile, when a device for photographing the golf ball is used separately from the photographing device for photographing the user's golf swing as described above, the photographing speed of the camera for photographing the golf ball and the photographing speed of the photographing device for photographing the golf swing may be integer multiples of each other. For example, if the photographing speed of the camera for photographing the golf ball is 2500 fps, the photographing speed of the photographing device for photographing the golf swing may be 312.5 fps, which is 1/8 of the former, and if the photographing speed of the camera for photographing the golf ball is 2400 fps, the photographing speed of the photographing device for photographing the golf swing may be 400 fps, which is 1/6 of the former.

By making the photographing speed of the camera for photographing the golf ball and the photographing speed of the photographing device for photographing the golf swing integer multiples of each other as described above, the two cameras are perfectly synchronized to eliminate the need for additional adjustment processes. This results in various effects such as easier frame alignment and comparison, simplified data comparison and analysis, easier post-processing and synthesis work, and elimination of time or ratio distortion.

In addition, the photographing device for photographing the user's golf swing may use a wide-angle lens capable of photographing a relatively wider field of view compared to the device for photographing the golf ball.

However, the luminaire included in the photographing device according to one embodiment of the invention and the type of light that may be captured or detected by the camera included in the photographing device are not limited to the examples described above.

Next, the 3D information generation unit 220 according to one embodiment of the invention may function to generate 3D information on the user's golf swing on the basis of the acquired at least one image of the user's golf swing.

The 3D information according to one embodiment of the invention is spatial information composed of three dimensions, i.e., width, height, and depth (where each dimension may be expressed as an x-axis, y-axis, and z-axis), and may refer to data including details of a distance, size, and shape of a subject. Specifically, the 3D information according to one embodiment of the invention may be, but is not limited to, a 3D virtual body model, a 3D avatar, or a golf swing motion of the user implemented using the 3D virtual body model or 3D avatar, which will be described later.

Generating the 3D information on the basis of the at least one image of the user's golf swing according to one embodiment of the invention may mean predicting depth information using a single 2D image that only contains width and height information. Specifically, predicting the depth information may mean inferring depth information of an object with the deep learning model according to one embodiment of the invention, using a single 2D image in which the user's golf swing is photographed. That is, by using the deep learning model according to one embodiment of the invention, the depth information may be predicted (or inferred) from only one 2D image without the need to use parallax, which is a relative positional difference that occurs when looking at the same target object from two different points (or angles).

Meanwhile, the 3D information generation unit 220 may visualize the information on the user's golf swing as a 3D virtual body model or 3D avatar.

The 3D virtual body model according to one embodiment of the invention may refer to a model that three-dimensionally reproduces a human body in a digital environment. Specifically, the 3D virtual body model according to one embodiment of the invention may include a skeletal structure that may minimally represent the user's golf swing motion, and may further include a surface mesh, muscle structure, skin color, and textures that may represent the user's individuality.

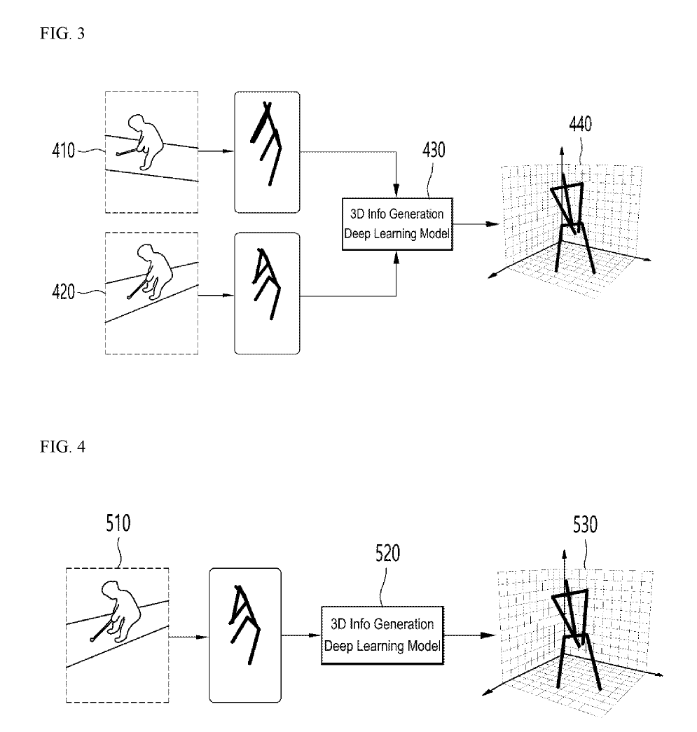

For example, referring to FIG. 3, the 3D virtual body model according to one embodiment of the invention may be expressed as 3D information 440 in FIG. 3, in which case the 3D virtual body model is a 3D body model where the arms, legs, torso, and head are minimally displayed as corresponding straight lines to reproduce the user's golf motion. However, this is merely an example, and the 3D virtual body model according to one embodiment of the invention is not limited thereto but may be diversely changed as long as it is consistent with the objects of the invention.

The 3D avatar according to one embodiment of the invention may refer to a three-dimensional character that represents the user in a digital environment or performs interactions in a virtual world.

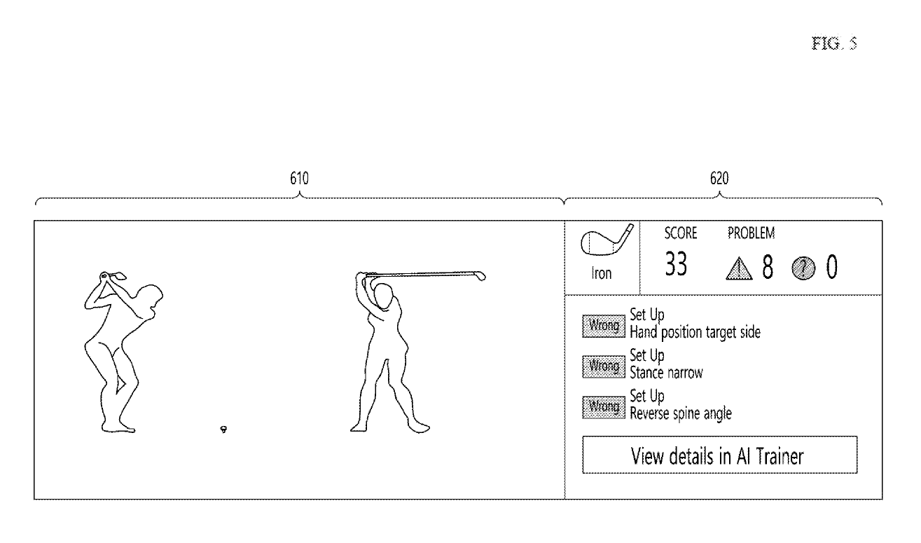

For example, referring to FIG. 5, the 3D avatar according to one embodiment of the invention may be expressed as a 3D avatar 610 in FIG. 5. However, this is merely an example, and the shape of the 3D avatar may be changed without limitation as long as it is consistent with the objects of the invention.

Meanwhile, the 3D virtual body model and the 3D avatar described above may be used interchangeably to mean the same 3D information, but may also be used distinctly from each other such that (i) the 3D virtual body model refers to a model in which the user's swing motion is expressed in 3D for the swing information provision system 200 according to one embodiment of the invention to analyze the user's golf swing, and (ii) the 3D avatar refers to a model for displaying a result of analyzing the swing motion to the user.

Specifically, when the 3D virtual body model and the 3D avatar are used distinctly, (i) is a model that implements only the skeleton for motion analysis and may mean, for example, the 3D information 440 in FIG. 3, and (ii) is a model implemented to display the swing motion to the user and may mean, for example, the 3D avatar 610 in FIG. 5.

Meanwhile, the 3D virtual body model or 3D avatar may be generated on the basis of the user's input, or generated on the basis of information on the user.

Generating the 3D virtual body model or 3D avatar on the basis of the user's input according to one embodiment of the invention may mean that the user may customize the 3D virtual body model or 3D avatar as desired.

For example, elements that may be customized according to the user's input include, but are not limited to, body type, height, face (e.g., facial features and skin color), facial expressions (e.g., upon a successful stroke), clothing, shoes, golf equipment, and voice (e.g., presence, volume, and tone of voice).

Meanwhile, generating the 3D virtual body model or 3D avatar on the basis of the information on the user according to one embodiment of the invention may be (i) generating the 3D virtual body model or 3D avatar on the basis of data on the user's appearance (e.g., a photograph of the user's full body or face), (ii) generating the 3D virtual body model or 3D avatar on the basis of the user's responses to a survey (e.g., the user selecting one of given options for questions related to gender, age, physical characteristics, preferred clothing style, preferred color, and the like (e.g., by voice)), or (iii) generating a character that may represent the user on the basis of information on the user collected through existing golf play styles (e.g., existing screen golf play history) or the like, which may mean various ways of generating the 3D virtual body model or 3D avatar while minimizing the user's input.

For example, in addition to acquiring the at least one image of the user's golf swing, the photographing device according to one embodiment of the invention may photograph the user's appearance and generate a 3D virtual body model or 3D avatar reflecting the user's characteristics on the basis of the photographed appearance. Meanwhile, the degree to which the user's characteristics are reflected may be adjusted as needed. For example, immersion may be enhanced by reflecting characteristics such as the user's face, body type, and attire appearing in the photographed appearance such that they appear as close as possible to the user in the 3D virtual body model or 3D avatar (i.e., making them as realistic as possible), but physical characteristics that the user does not want to reveal may be appropriately hidden by reflecting only some of the characteristics appearing in the photographed appearance (e.g., only information minimally necessary for implementing a swing motion, such as height and limb length) and not reflecting the face or other physical characteristics.

Meanwhile, the 3D virtual body model or 3D avatar according to one embodiment of the invention may be generated automatically in the manner described above, and then modified on the basis of the user's input.

Next, the generation of the 3D information according to one embodiment of the invention is performed through a deep learning model.

Specifically, the deep learning model for generating the 3D information according to one embodiment of the invention may refer to a model for estimating 3D information of a specific object (e.g., the above-described 3D virtual body model or 3D avatar) using at least one 2D image of the object.

Specifically, the deep learning model may be a model for combining a multi-view stereo (MVS) technique with a deep learning technique to estimate a depth and surface structure of an object from at least one 2D image of the object, thereby generating 3D information of the object.

More specifically, while traditional multi-view stereo techniques require manual setting of feature points on 2D images and have the disadvantage of low accuracy in depth information estimation when image quality is low or textures are insufficient, the deep learning model according to the invention may combine the MVS technique with the deep learning technique to (i) automate the feature extraction and matching processes, significantly increasing computation speed, and (ii) allow the deep learning model to learn context information and make compensation even when image quality is low or textures are insufficient. This enables the extraction of richer, high-dimensional features from 2D images across various environments (including those with insufficient textures or low image quality due to photographing conditions), ensuring consistently high accuracy in depth information estimation despite environmental changes.

The deep learning model according to one embodiment of the invention may be trained using at least one (or all) of the following: 2D images of a golf swing that do not include labels for the 3D information, information on general characteristics of a golf swing, and information on extrinsic parameters of the photographing device used to photograph the 2D images of the golf swing that do not include labels for the 3D information.

Referring to FIG. 3, the deep learning model according to one embodiment of the invention may refer to a 3D information generation deep learning model 430 that is trained to extract a skeletal structure and its movement corresponding to the user's swing motion from overhead view 2D images photographed from two or more different angles (i.e., a first overhead view 2D image 410 and a second overhead view 2D image 420), thereby generating the 3D information 440 from just a single 2D image.

Specifically, the deep learning model according to one embodiment of the invention may be trained to infer 3D information from an 2D image using training data that contains two or more overhead view 2D images in which a single golf swing is photographed from to two or more different angles. That is, the deep learning model according to one embodiment of the invention may be trained using training data that contains two or more overhead view 2D images during a training phase, and may then infer 3D information through just a single 2D image during an inference phase.

The 2D images photographed from different angles (or viewpoints) described above in connection with the training data for the deep learning model according to one embodiment of the invention may refer to two or more 2D images with an angular difference sufficient to calculate the depth and shape of the subject (i.e., the user's golf swing) to infer a 3D structure. Specifically, the angular difference may be smaller as a distance between the photographing device for photographing the 2D images and the user is smaller, while the angular difference may be larger as the distance may be greater. Meanwhile, the angular difference may be changed without limitation as it is consistent with the objects of the invention, considering the distance between the photographing device and the user or the level of detail of the 3D information to be generated. For example, the angular difference may range from 5 to 15 degrees, but is not limited thereto.

Referring further to FIG. 3, the two or more overhead view 2D images photographed from different angles may be 2D images having different photographing angles that are photographed from a relatively higher location compared to the user (or golfer), like the first overhead view 2D image 410 and the second overhead view 2D image 420. The 2D images (or one of them) may be converted into the3D information 440 through the 3D information generation deep learning model 430 to be described later.

Examples of the deep learning model for generating the 3D information include, but are not limited to, NeRF (Neural Radiance Fields), Pix2Vox, MVSNet (Multi-View Stereo Network), DeepVoxels, and COLMAP.

Training the deep learning model according to one embodiment of the invention using information on 2D images that do not include labels for the 3D information may mean that the training is performed with training data that has no separate labeling. Specifically, the training data without labeling (or "ground truth") may refer to data without 3D information (e.g., information such as a point cloud, mesh structure, or depth map) actually measured for a specific object with respect to 2D images of the specific object. That is, training without separate labeling may mean that the training is performed without provision of prior specific instructions or labels for the 3D structure represented by the 2D images.

The deep learning model according to one embodiment of the invention may be trained using information on general characteristics of a golf swing and information on extrinsic parameters of the aforementioned photographing device, in addition to the 2D images of the golf swing described above.

Further, the information on general characteristics of a golf swing according to one embodiment of the invention may refer to common characteristics that any typical golf swing must possess, rather than characteristics of a golf swing that differ for each individual user. For example, the information on general characteristics of a golf swing may include (i) the fact that a golf club must be held with both hands, (ii) the fact that a lead hand and a trail hand are distinguished, and (iii) the fact that general and common swing stages (e.g., consisting of an address, a back swing, a down swing, an impact, and a follow-through in that order) exist for all golf swings. That is, considering that the subject being photographed is primarily a golf swing, the photographing device according to one embodiment of the invention may improve the accuracy of training and inference by using characteristics appearing in a general golf swing (rather than characteristics limited only to the user's golf swing) during the training process.

Further, the information on general characteristics of a golf swing according to one embodiment of the invention may include the fact that the same 3D object (i.e., the user or the user's swing motion) is photographed in the images. Specifically, by using the fact that the same 3D object (i.e., the user or the user's swing motion) is photographed in the images as training data, the 3D information may be estimated with high accuracy even if the training is performed using only data without separate labeling on how feature information included in the overhead view 2D images is associated with information on the 3D structure or depth of the actual 3D object.

Further, the information on extrinsic parameters of the photographing device according to one embodiment of the invention may refer to parameters defining a position and direction of the photographing device (e.g., a camera) in the world coordinate system. The parameters may indicate where the photographing device is positioned within 3D space and how it is rotated.

Specifically, the extrinsic parameters may consist of a translation vector and a rotation matrix, through which it is possible to determine how a point in 3D space will appear in the camera coordinate system and define a relationship when a 3D object is projected onto a 2D image. Meanwhile, the translation vector refers to a parameter representing a position of the camera, and may be a vector indicating from which viewpoint the camera is looking at an object at a specific position, and the rotation matrix refers to a parameter representing in which direction the camera is rotated in 3D space, and may be, for example, a 3x3 matrix by which a transformation that rotates the world coordinate system into the camera coordinate system may be performed.

Further, training the deep learning model using the information on the extrinsic parameters of the photographing device according to one embodiment of the invention may mean that, in the case of the overhead view 2D images acquired through the photographing device according to one embodiment of the invention, considering the fact that extrinsic parameters such as a position and photographing angle of the photographing device used to photograph the 2D images are known (i.e., the position of the photographing device and the position where the user performs the swing are fixed), the deep learning model is trained using the information on the extrinsic parameters as training data together with the overhead view 2D images. Generally, when a deep learning model is trained to generate 3D information using 2D images, there are many cases where there is no information on a position or angle of a photographing device used to photograph the 2D images used as the training data. However, since the extrinsic parameters of the photographing device used to photograph the overhead view 2D images according to one embodiment of the invention are accurately known, the model may be trained to have higher estimation accuracy by including information on the extrinsic parameters in the training data. Further, when the deep learning model according to one embodiment of the invention estimates the 3D information through the two or more overhead view 2D images photographed from different angles, estimation efficiency may be increased using the fact that the overhead view 2D images and the 3D information to be estimated are related to a golf swing motion. For example, since both of the user's hands are holding the golf club in all cases of a golf swing, the deep learning model may use this fact to more accurately estimate the 3D information (or golf swing motion).

Consequently, the deep learning model according to one embodiment of the invention may be trained on the basis of two or more 2D images acquired by photographing a single golf swing through overhead views from two or more different angles, and may be further trained on the basis of information on general characteristics of a golf swing and information on extrinsic parameters of the photographing device. The trained deep learning model may generate (or infer) 3D information on the user's golf swing on the basis of at least one image of the user's golf swing, or generate (or infer) 3D information on the user's golf swing on the basis of at least one image of the user's golf swing and information on extrinsic parameters of the photographing device.

In summary, the deep learning model that has completed training according to one embodiment of the invention may accurately generate (or infer) the 3D information using only one overhead view 2D image photographed from a single angle (i.e., photographed by the photographing device having only one camera for photographing from one angle) as described above, just as in the case of using two overhead view 2D images photographed from different angles. That is, because the deep learning model according to one embodiment of the invention is trained to generate accurate 3D information from an overhead view 2D image using various information during the training process as described above, it may generate the 3D information during the inference process using only an image (or overhead view image) in which the user's swing is photographed from one direction.

For example, referring to FIG. 4, unlike generating the 3D information through two different overhead view 2D images during the training process, 3D information 530 may be estimated with high accuracy by inputting only one overhead view 2D image 510 into a 3D information generation deep learning model 520 that has completed training.

Further, the deep learning model according to one embodiment of the invention may estimate the 3D information not only when there are two overhead view 2D images photographed from different angles (i.e., when the photographing device has two cameras for photographing views from different angles), but also when there are three or more (i.e., when the photographing device has three or more cameras for photographing views from different angles). That is, the deep learning model according to one embodiment of the invention may accurately estimate the 3D information for all cases where the number of cameras is one or more, without any separate modification to the model structure.

Meanwhile, the accuracy of inferring the 3D information may be improved as there are more types of overhead view 2D images photographed from different angles (i.e., the types of overhead view angles). However, it is noted that this does not mean that the inference accuracy is low when estimating the 3D information on the basis of only an overhead view image photographed from a single angle as described above. That is, the trained deep learning model according to one embodiment of the invention may estimate the 3D information with sufficient accuracy for analyzing a golf swing, even on the basis of only an overhead view image photographed from a single angle.

Next, the swing information display unit 230 according to one embodiment of the invention may function to display the generated 3D information on the user's golf swing.

The 3D information on the golf swing according to one embodiment of the invention may refer to (i) a 3D virtual body model or 3D avatar itself corresponding to the user, or (ii) a swing motion of the user implemented through the 3D virtual body model or 3D avatar.

Displaying the 3D information on the user's golf swing according to one embodiment of the invention may mean displaying the 3D information on the user's golf swing such that the user may perceive it in the swing information provision system 200 according to one embodiment of the invention or a virtual golf play system including the same (e.g., a screen golf system or a virtual golf game). Specifically, displaying the 3D information on the user's golf swing may include displaying the 3D information on a screen or display so that the user may visually perceive it.

For example, referring to FIG. 5, the user's swing motion may be represented through the 3D avatar 610, and the same swing motion viewed from the front view (right side of 610) and the rear view (left side of 610) may be displayed simultaneously. That is, the swing information display unit 230 according to one embodiment of the invention may display the user's swing motion implemented through the 3D avatar 610 on a screen or display so that the user may visually perceive it.

Meanwhile, the swing information display unit 230 according to one embodiment of the invention may display the information on the user's golf swing in at least one of a fixed view, a non-fixed view, and a view manipulatable according to the user's input.

The swing information display unit 230 according to one embodiment of the invention may display the information on the user's swing implemented as the above-described 3D model in various ways, and these various ways may refer to the types of views for displaying the generated 3D virtual body model or 3D avatar of the user. Specifically, the types of views may be largely classified into (i) a fixed view, (ii) a non-fixed view, and (iii) a view manipulatable according to the user's input.

First, the fixed view may mean that the viewpoint is fixed and does not move while looking at the 3D virtual body model or 3D avatar. For example, the fixed view may include, but is not limited to, fixed viewpoints such as a face-on view (where the golfer faces the camera and the camera is positioned to the side of the golfer), a front view (where the camera is positioned in front from the direction the golfer is looking toward the target), a rear view (looking toward the target from behind the golfer's swing direction), a top view (looking down at the golfer from above), a 45-degree diagonal view (looking at the golfer diagonally), and a toe-up view (looking up at the golfer from the ground or the golfer's feet).

Next, the non-fixed view may refer to a view where the viewing direction moves (continuously). For example, it may be, but is not limited to, a view where the camera rotates 360 degrees around the user (or golfer) starting from a specific front view, and may include any view where the camera moves. The camera may move automatically without the user's input (e.g., starting from a front view and continuously rotating at a constant speed while displaying the 3D avatar), and the direction, trajectory, or speed of the camera movement may be changed without limitation as long as they are consistent with the objects of the invention.

Next, the view manipulatable according to the user's input may mean that the view changes in response to the user's input. For example, in a situation where the 3D information is being displayed in the fixed or non-fixed view, the view manipulatable according to the user's input may include a view where the user may manipulate the view to a specific angle in the left, right, up, or down direction through a specific input.

Specifically, the user's input should be understood as encompassing all types of interactions occurring between the user and the swing information provision system 200 according to one embodiment of the invention or various devices including the same. Specifically, the user's input includes, but is not limited to, (i) a physical input directly manipulating a physical interface such as buttons or a touchpad, (ii) a voice input for commanding or providing information by voice, (iii) a gesture input where the user interacts with the device through specific hand movements, facial expressions, or body movements, (iv) a gaze input where the user's gaze is tracked and recognized as an input, and (v) a touchless input where the user may provide an input from a certain distance without directly touching the device, such as a proximity sensor input, an air gesture, and an input based on an ultrasonic/infrared sensor.

More specifically, the user's input according to one embodiment of the invention may be a motion gesture using the user's (or golfer's) hand, arm, or the golf club held by the user. Specifically, a function may be implemented to recognize a swipe direction appearing in the motion of the user's hand or arm using the photographing device according to one embodiment of the invention, and use the swipe direction to rotate the view of the 3D virtual body model or 3D avatar in a specific direction, or to rewind or fast-forward a displayed video of the user's swing motion. For example, while practicing a golf swing, the user may swing the golf club held in his/her hand to the left to rewind the 3D-implemented swing motion video (e.g., moving the video back x seconds) or swing it to the right to fast-forward the swing motion video (e.g., moving the video forward x seconds) instead of operating a specific device.

Next, the feedback display unit 240 according to one embodiment of the invention may function to display feedback on the user's swing generated on the basis of the information on the user's golf swing implemented in 3D.

The feedback on the user's swing according to one embodiment of the invention should be understood as encompassing all types of information or advice related to improvements in the user's swing motion, which is determined on the basis of information acquired by analyzing the user's swing motion using the 3D information including the information on the user's swing motion described above. Specifically, the feedback according to one embodiment of the invention may be displayed together with the 3D virtual body model, 3D avatar, or the user's swing motion implemented through the 3D virtual body model or 3D avatar.

For example, referring to FIG. 5, the feedback information may be displayed as swing information 620 including feedback, together with the 3D avatar 610 and various swing-related information such as the type of club currently in use, and a score for the swing motion and problems (and the number of problems) may also be displayed together. In particular, the feedback may be provided in a manner that problems appearing in the user's motion are listed or in a manner that the problems are listed and improvement plans for them are provided, for example.

Meanwhile, the problems may refer to differences that appear in the user's swing motion compared to a pre-inputted swing motion, and the pre-inputted swing motion may be a motion selected as a reference swing motion, such as a professional golfer's swing motion.

Referring further to FIG. 5, the feedback may be provided in a manner that problems observed in the user's swing motion are listed such as (i) hand position target side (a state where the hands are out toward the target at or above a certain level), (ii) stance narrow (a state where the gap between both feet is not wide enough), and (iii) reverse spine angle (a state where the spine is bent in the opposite direction as the upper body tilts toward the target during a back swing).

Meanwhile, the feedback may include an analysis of change trends of a plurality of feedbacks that have been provided for a plurality of user swing motions. For example, in a situation where a problem of the hands being too far toward the target in one swing was pointed out and provided as feedback, (i) if the same problem occurs in the next swing, it may be emphasized more than other problems (e.g., by using a specific expression or placing it at the top of the problem list), and (ii) if the problem does not occur in the next swing, the user may be notified that the problem has been resolved, or a phrase praising this may be displayed.

Next, the information management unit 250 according to one embodiment of the invention may function to store the information on the user's golf swing implemented in 3D, and load or transmit the stored information on the user's golf swing.

Storing the information on the user's golf swing implemented in 3D by the information management unit 250 according to one embodiment of the invention may mean recording the generated 3D information (e.g., the 3D virtual body model,3D avatar, or the user's swing motion implemented using the 3D virtual body model or 3D avatar) in a separate storage device. The separate storage device may be a physical storage device such as a hard disk drive or a memory card, or may be a storage device such as cloud storage that is stored (or uploaded) to a remote server and accessed through a network.

Loading or transmitting the stored information on the user's golf swing by the information management unit 250 according to one embodiment of the invention may mean loading the generated and stored 3D information in the swing information provision system 200 according to one embodiment of the invention or a device including the same, or transmitting it to another system (or device).

Specifically, loading the stored information on the user's golf swing may mean loading the 3D information of the current user (i.e., the golfer using the swing information provision system 200 at the time of selecting the user to load golf swing information) among pre-stored 3D information of a plurality of users (e.g., 3D body models, 3D avatars, past swing history, past feedback provision history, or contents of provided feedback) as needed.

For example, it may be assumed that user A and user B are using a screen golf system that includes the swing information provision system 200 according to one embodiment of the invention. In this situation, when user A plays screen golf, user A's 3D avatar or past swing history may be loaded in response to the current player of the screen golf being determined to be user A through a means capable of specifying user A (e.g., login or facial recognition).

Meanwhile, transmitting the stored information on the user's golf swing may mean transmitting the information on the user's golf swing to another system or device distinct from the swing information provision system 200 according to one embodiment of the invention or a device including the same. Specifically, the 3D information according to one embodiment of the invention may be stored (or uploaded) on a cloud network in association with the user's personal ID or the like, and then another system or device may load (or download) the3D information from the network and utilize it.

For example, the user may use a 3D avatar by creating the 3D avatar in a screen golf system and receiving feedback on the user's swing motion implemented through the 3D avatar, and then the information is loaded in another virtual simulation golf game and the user's 3D avatar, swing motion, and the like are provided so that an opponent on the network may view the information. That is, the 3D information according to one embodiment of the invention may be used in various ways without platform limitations in a cross-platform manner.

Next, the communication unit 260 according to one embodiment of the invention may function to enable data transmission/reception from/to the image acquisition unit 210, the 3D information generation unit 220, the swing information display unit 230, the feedback display unit 240, and the information management unit 250.

Lastly, the control unit 270 according to one embodiment of the invention may function to control data flow among the image acquisition unit 210, the 3D information generation unit 220, the swing information display unit 230, the feedback display unit 240, the information management unit 250, and the communication unit 260. That is, the control unit 270 according to one embodiment of the invention may control data flow into/out of the swing information provision system 200 or data flow among the respective components of the swing information provision system 200, such that the image acquisition unit 210, the 3D information generation unit 220, the swing information display unit 230, the feedback display unit 240, the information management unit 250, and the communication unit 260 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network

200: swing information provision system

210: information acquisition unit

220: 3D information generation unit

230: swing information display unit

240: feedback display unit

250: information management unit

260: communication unit

270: control unit

300: device

410: first overhead view 2D image

420: second overhead view 2D image

430: 3D information generation deep learning model

440: 3D information

510: one overhead view 2D image

520: trained 3D information generation deep learning model

530: 3D information

610: 3D avatar

620: swing information including feedback

What is claimed is:

1. A method for providing information on a golf swing, the method comprising the steps of:
acquiring at least one image of a user's golf swing; and
generating three-dimensional (3D) information on the user's golf swing on the basis of the acquired at least one image of the user's golf swing,
wherein the generation of the 3D information is performed through a deep learning model.

2. The method of claim 1, wherein in the acquiring step, at least one overhead view two-dimensional (2D) image of the user's golf swing is acquired through at least one photographing device.

3. The method of claim 1, wherein the deep learning model is trained using at least one of 2D images of the golf swing that do not include labels for the 3D information, information on general characteristics of a golf swing, and information on extrinsic parameters of a photographing device used to photograph the 2D images of the golf swing that do not include labels for the 3D information.

4. The method of claim 3, wherein the 2D images of the golf swing are two or more 2D images acquired by photographing a single golf swing through overhead views from two or more different angles.

5. The method of claim 4, wherein the deep learning model is trained further using a fact that a single golf swing is photographed in the two or more 2D images of the golf swing.

6. The method of claim 2, wherein in the acquiring step, information on a golf ball is further acquired through the at least one photographing device.

7. The method of claim 1, wherein in the generating step, the information on the user's golf swing is visualized as a 3D virtual body model or 3D avatar.

8. The method of claim 7, wherein the 3D virtual body model or 3D avatar is generated on the basis of the user's input or information on the user.

9. The method of claim 1, further comprising the step of:
displaying the generated 3D information on the user's golf swing.

10. The method of claim 9, wherein in the displaying step, the information on the user's golf swing is displayed in at least one of a fixed view, a non-fixed view, and a view manipulatable according to the user's input.

11. The method of claim 1, further comprising the step of:
displaying feedback on the user's golf swing generated on the basis of the 3D information on the user's golf swing.

12. The method of claim 1, further comprising the step of:
storing the 3D information on the user's golf swing, and loading or transmitting the stored information on the user's golf swing.

13. A non-transitory computer-readable recording medium having stored thereon a computer program for executing the method of claim 1.

14. A system for providing information on a golf swing, the system comprising:
an image acquisition unit configured to acquire at least one image of a user's golf swing; and
a three-dimensional (3D) information generation unit configured to generate 3D information on the user's golf swing on the basis of the acquired at least one image of the user's golf swing,
wherein the generation of the 3D information is performed through a deep learning model.

15. The system of claim 14, wherein the image acquisition unit is configured to acquire at least one overhead view two-dimensional (2D) image of the user's golf swing through at least one photographing device.

16. The system of claim 14, wherein the deep learning model is trained using at least one of 2D images of the golf swing that do not include labels for the 3D information, information on general characteristics of a golf swing, and information on extrinsic parameters of a photographing device used to photograph the 2D images of the golf swing that do not include labels for the 3D information.

17. A photographing device comprising:
a camera capable of acquiring at least one overhead view two-dimensional (2D) image of a user's golf swing.

18. The photographing device of claim 17, wherein the photographing device is positioned at a location relatively higher than the user.

19. The photographing device of claim 17, further comprising:
a camera capable of acquiring at least one image of a golf ball.

20. The photographing device of claim 19, wherein the photographing device includes a camera capable of acquiring two different overhead view 2D images of the user's golf swing and a camera capable of acquiring two different images of the golf ball.
